(19) United States
(12) Patent Application Publication
(10) Pub. No.: US 2007/0074964 A1
(43) Pub. Date: Apr. 5, 2007

(54) Telescoping fluid actuator

(75) Inventor: Gary L. Miller, Chaska, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Vector Engineering Co., Chaska, MN (US)

(21) Appl. No.: 11/242,521

(22) Filed: Oct. 3, 2005

(51) Int. Cl. H01H 35/38

(52) U.S. Cl. 200/82 R

(57) ABSTRACT

A telescoping housing for a single acting fluid actuator includes an outer actuator housing section and an inner actuator housing section mounted to reciprocate axially relative to the outer housing section while being surrounded thereby. The housing sections cooperate to form a chamber, and the housing is extended axially by supplying an actuator fluid under pressure to the chamber. A positive pressure is maintained in the chamber to avoid infiltration of outside contaminants into the chamber. Retraction is accomplished by reducing the fluid pressure sufficiently to allow the housing to retract under the influence of gravity, spring force, or other external force. The telescoping housing design eliminates the need for a reciprocating piston and piston rod.

### BACKGROUND OF THE INVENTION

The present invention relates to fluid actuators such as hydraulic and pneumatic cylinders and motive systems in which these cylinders are employed, and more particularly to the housings of these cylinders.

In many industries, the need arises for localized applications of considerable force in areas that lack sufficient space to accommodate motors or engines capable of generating the required forces. Fluid actuators are well suited to meet these needs. A typical actuator construction includes an actuator housing composed of an elongate cylinder and two opposite end caps, a piston that reciprocates axially within the cylinder, and a piston rod mounted to reciprocate with the piston. One of the end caps has a central opening to accommodate the rod, while the other, known as a “blind” end cap, completely closes its end of the cylinder.

Motive force is generated by providing a fluid to the housing between the piston and one of the end caps, to drive the piston toward the other end cap. In hydraulic systems, the actuator fluid is an incompressible fluid, such as oil. In pneumatic systems, the fluid is a compressible fluid such as air or another pneumatic gas.

In either event, a broad range of new applications has increased the demand for actuators that are more reliable, yet produced at lower cost. In dusty or other more demanding environments, there is a need to reduce or eliminate infiltration during retraction of the piston. The desire to ensure that the housing cylinder, piston, rod, and end cap that accommodates the rod are concentric requires a high level of precision machining of these parts. Seals capable of accommodating relative motion are required at the piston/cylinder interface and the rod/end cap interface. Accordingly, there is a need for an improved fluid actuator design.

Therefore, it is an object of the present invention to provide a fluid actuator that is less susceptible to infiltration during retraction and other stages of actuator operation.

Another object is to provide a fluid actuator housing construction that requires fewer seals.

A further object is to provide a fluid actuator of simpler design and having fewer essential components.

Yet another object is to provide a lower cost, more efficient process for manufacturing housings for fluid actuators.

### SUMMARY OF THE INVENTION

To achieve these and other objects, there is provided a fluid actuator including a first actuator housing section having a first-section end wall, a first open end opposite the first-section end wall, and a first-section side wall extending in a longitudinal direction between the first-section end wall and the first open end. A second actuator housing section of the actuator has a second-section end wall, a second open end opposite the second-section end wall, and a second side wall extending in a longitudinal direction between the second-section end wall and the second open end. The second actuator housing section is disposed in opposition to the first actuator housing section with the second-section side wall surrounded by the first-section side wall and with the second open end confronting the first-section end wall. Thus, the first and second actuator housing sections cooperate to form an actuator housing with an enclosed chamber extending longitudinally between the first-section end wall and the second-section end wall. The second actuator housing section is adapted to reciprocate longitudinally with respect to the first actuator housing section, between an extended state in which the first-section end wall and second-section end wall are relatively remote from each other, and a retracted state in which the first-section end wall and the second-section end wall are relatively proximate to each other, thus to alternatively longitudinally expand and contract the actuator housing. A fluid supply component is fluid-coupled to the chamber and adapted to supply an actuator fluid under pressure to the chamber, to longitudinally expand the actuator housing.

Thus, the reciprocating sections provide a telescoping actuator housing. A salient feature of this construction is that it eliminates the need for a piston and piston rod, since the motive force is generated through relative movement of the first and second actuator housing sections. Wipe-action seals at the piston/cylinder interface and rod/end cap interface of conventional cylinder constructions, are replaced functionally by a single seal at the interface of the first and second actuator housing sections, more particularly between the first and second side walls. The actuator housing sections preferably are an aluminum alloy and are formed by impact extrusion, thus to require relatively little precision machining. In any event, with only two components that need to be machined, production and assembly costs are reduced.

In preferred constructions, the first and second side walls are cylindrical and concentric on a longitudinal axis. To enhance stability and ensure a more effective seal, the first side wall is crimped or otherwise radially reduced along an annular end region near the open end for a contiguous, sliding engagement with the outside surface of the second side wall. A wear ring is advantageously disposed between the end region and second side wall. To further stabilize the arrangement, a second wear ring is positioned between the second side wall near its open end and an inside surface of the first side wall. The wear ring is formed with a break to allow passage of air (or oil in hydraulic versions) between the chamber and a narrow, annular gap between the first and second side walls with a maximum length when the housing is retracted. This eliminates the need for the housing to “breathe,” thus to minimize the chance for contamination from the environment outside the housing.

Another aspect of the invention is a process for assembling a fluid actuator housing, including the following steps:

(a) providing a first actuator housing section having a first-section end wall, a first open end opposite the first-section end wall, and a first-section side wall extending in an axial direction between the first-section end wall and the first open end;

(b) providing a second actuator housing section having a second-section end wall, a second open end opposite the second-section end wall, and a second-section side wall extending in an axial direction between the second-section end wall and second open end, wherein an outside diameter of the second-section side wall is less than an inside diameter of the first-section side wall;

(c) inserting the second actuator housing section axially into the first actuator housing section such that the first-section side wall surrounds the second-section side wall and the second open end confronts the first-section end wall;

(d) with the second actuator housing section so inserted, permanently radially reducing an end region of the first-section side wall proximate the first open end, to secure the second actuator housing section against removal from the first actuator housing section while permitting the second actuator housing section to travel axially relative to the first actuator housing section.

A salient advantage of this process is the absence of a piston and piston rod, and the resulting elimination of the need to concentrically align the piston, the rod, the cylinder surrounding the piston, and the end cap or other end structure designed to accommodate the rod.

Further in accordance with the present invention, there is provided a fluid actuator system including an actuator housing comprising a first actuator housing section having a first end wall and an axially extending first side wall, and a second actuator housing section having a second end wall and an axially extending second side wall. The second actuator housing section is mounted to reciprocate axially relative to the first actuator housing section between extended and retracted states with the first side wall in surrounding relation to the second side wall. The first and second actuator housing sections cooperate to define a chamber with the first and second end walls disposed at opposite ends of the actuator housing to determine opposite ends of the chamber. The system further includes a fluid source containing a fluid. A fluid supply path extends from the fluid source to the chamber. A fluid pump is disposed along the fluid supply path, and is operable to convey the fluid from the fluid source into the chamber under pressure to cause the second actuator housing section to travel axially toward the extended state.

When the actuator housing is retracted under an external force, a positive pressure is maintained while the fluid is evacuated from the chamber. This further reduces the potential for infiltration from the environment outside the housing. In most applications, the first housing section remains substantially fixed while the second housing section axially reciprocates. In such cases and in others, the fluid supply path includes a passage through the end wall of the first actuator housing section.

Thus in accordance with the present invention, a fluid actuator housing is formed with telescoping sections to eliminate the need for the reciprocating piston and piston rod found in conventional fluid actuators. This reduces the number of required parts, and along with it the manufacturing costs and complexity. Further, the reciprocating sections virtually eliminate the potential for contamination due to infiltration from the ambient environment, during actuator extension and retraction.

### IN THE DRAWINGS

Further features and advantages will become apparent upon consideration of the following detailed description and the drawings, in which:

FIG. 1 is a side elevation of a fluid actuator housing constructed in accordance with the present invention;

FIG. 2 is a sectional view taken along the line 2-2 in FIG. 1, showing the housing in a retracted position;

FIG. 3 is a partially sectioned side elevation of an alternative embodiment fluid actuator housing;

FIG. 4 is a sectional view taken along the line 4-4 in FIG. 3, showing the housing retracted;

FIG. 5 is an exploded parts view of a further alternative embodiment fluid actuator housing;

FIGS. 6 and 7 are sectional views of the housing of FIG. 5, retracted and extended, respectively;

FIG. 8 is a partial sectional view of the housing, taken along the line 8-8 in FIG. 6;

FIG. 9 is a partially sectioned view of yet another alternative embodiment fluid actuator housing; and

FIG. 10 schematically illustrates a system incorporating a fluid actuator, constructed in accordance with the present invention.

### DETAILED DESCRIPTION OF THE PREFERRED EMBODIMENTS

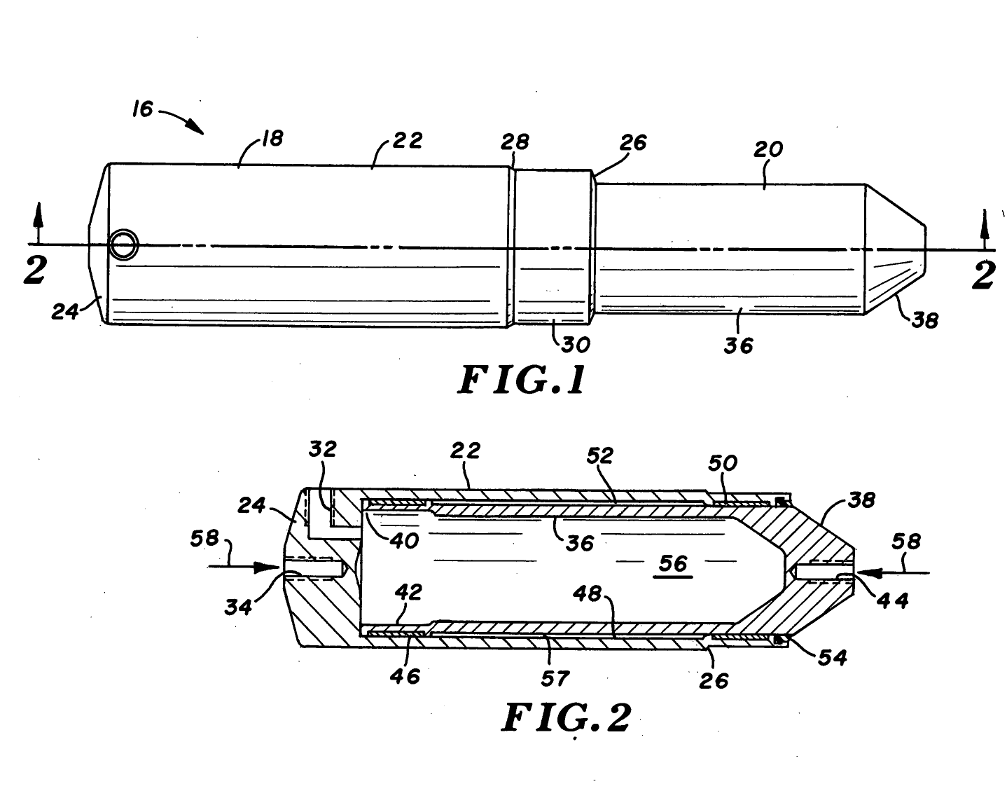

Turning now to the drawings, there is shown in FIGS. 1 and 2 a fluid actuator 16, which can be either a hydraulic cylinder or a pneumatic cylinder. Actuator 16 has an elongate, telescoping cylindrical housing, including an outer actuator housing section 18 and an inner actuator housing section 20 mounted for longitudinal (axial) reciprocation relative to housing section 18 to alternatively extend and retract the housing.

Outer housing section 18 has an elongate, axially extending annular side wall 22, an end wall 24, and an open end 26 opposite the end wall. Near the open end, side wall 22 is inclined radially inwardly as indicated at 28 to form a reduced-diameter end region 30. As best seen in FIG. 2, end wall 24 has a width in the axial direction sufficient to accommodate a fluid passage 32 and a centered, axially extending opening 34 to facilitate mounting actuator 16 in a desired operating environment. Opening 34 typically has internal threads.

Inner housing section 20 includes a longitudinally extending side wall 36 and an end wall 38. As seen in FIG. 2, inner housing section 20 has an open end 40 opposite the end wall. Near open end 40, side wall 36 is inclined radially outward to provide an enlarged-diameter end region 42. End wall 38 has an axial width sufficient to accommodate an opening 44 which, like opening 34 of opposite end wall 24, is internally threaded and facilitates the mounting of actuator 16 in the working environment. Actuator housing sections 18 and 20 preferably are formed of aluminum.

Actuator 16 further includes components that guide and facilitate axial reciprocation of the housing sections. An annular bearing or wear ring 46 surrounds inner housing section 20 along end region 42, retained against axial movement with respect to housing section 20. Bearing 46 is contiguous with and slidable relative to an inside surface 48 of side wall 22. Similarly, an annular bearing or wear ring 50 is disposed between end region 30 and side wall 36, constrained against axial movement relative to side wall 22 while being contiguous with and slidable relative to an outside surface 52 of side wall 36. Bearings 46 and 50 preferably are formed of brass, impregnated or coated with polytetrafluoroethylene (PTFE) at least along their sliding surfaces.

An annular seal 54 is mounted integrally with outer housing section 18 near open end 26, and surrounds inner housing section 20 in a slidable sealing/wiping engagement with outside surface 52 of side wall 20. Seal 54 is formed of a suitable polymer such as polyurethane.

Housing sections 18 and 20 cooperate to form a substantially enclosed chamber 56 inside the housing. With side wall 22 in surrounding relation to side wall 36, inner housing section 20 is mounted to reciprocate axially relative to outer housing section 18 between an extended state (FIG. 1) in which end walls 24 and 38 are relatively remote from one another, and a retracted state (FIG. 2) in which the end walls are relatively proximate each other. The retracted state is determined by the engagement of side wall 36 at open end 40 with end wall 24.

As seen in FIG. 2, the bearings and side wall end regions determine a narrow annular gap 57 between side walls 22 and 36 when actuator 16 is retracted. As the actuator is extended, gap 57 is progressively reduced in volume as its axial length shortens. To ensure against a pressure buildup in the gap, bearing 46 is configured to allow passage of air (or oil) between gap 57 and chamber 56. This avoids a pressure buildup in gap 57 during housing extension, which if present would work against extension.

Actuator 16 is operated by supplying an actuator fluid through fluid passage 32 into chamber 56, extending the housing in opposition to a force represented by arrows 58 that tends to maintain the actuator housing in the retracted state. The force may be a spring force, or may be due to gravity from the weight of a component supported by the actuator. In any event, outer housing section 18 typically is held stationary or mounted pivotally relative to a fixed location, while the inner housing section reciprocates.

The actuator fluid can be a substantially incompressible fluid such as oil in a hydraulic system, or a compressible fluid such as air in a pneumatic system. In either event, pressure to the fluid can be applied in a controlled manner to determine both the rate and the amount of housing extension. One advantage of the telescoping housing construction is reduced potential for contamination from the environment surrounding the housing. In conventional actuators, retraction temporarily develops a relative vacuum in the chamber upstream of the piston, which may cause ambient air including entrained particles to be drawn into the chamber. Retraction of actuator 16, in contrast, does not create a relative vacuum in the chamber. Instead, a positive pressure is present throughout the chamber during retraction. The capacity to resist infiltration is particularly beneficial for actuators used in environments with high concentrations of particulates or corrosive elements.

Another advantage of actuator 16 is that it requires only one sealing interface, namely seal 54 between side walls 22 and 36. Conventional piston/rod actuator housings require up to five sealing interfaces, one between the housing wall and piston, one between the blind end wall or cap and the housing, one between rod end wall or cap and the housing, another between the piston rod and the end wall or cap that accommodates the rod, and sometimes one between the rod and piston.

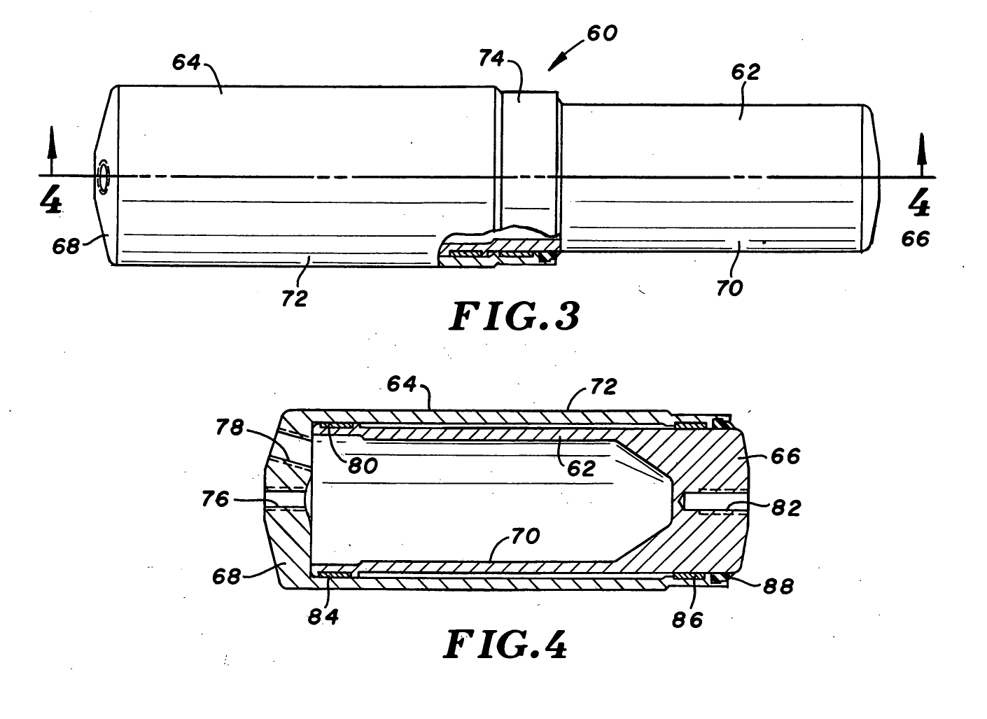

FIGS. 3 and 4 illustrate an alternative embodiment fluid actuator 60 with a housing formed by telescoping inner and outer housing sections 62 and 64 having respective end walls 66 and 68 and side walls 70 and 72. As before, each of the housing sections has an open end opposite its end wall.

Side wall 72 of the. outer housing section includes a reduced-diameter end region 74 near its open end. End wall 68 accommodates an opening 76 for mounting the actuator in a working environment, and a fluid passage 78 that is inclined and linear, as compared to the “L” shape of passage 32.

Side wall 70 includes an enlarged-diameter end region 80 near its open end. End wall 66 accommodates an opening 82 for mounting the actuator. Annular bearings 84 and 86, and an annular seal 88, are positioned and function in the manner described in connection with actuator 16.

A portion of FIG. 3 is cut away to reveal the manner in which end region 74 of side wall 72 and end region 80 of side wall 70 function as limiting features, by engaging one another when inner housing section reaches the extended state, to prevent any further extension of the housing.

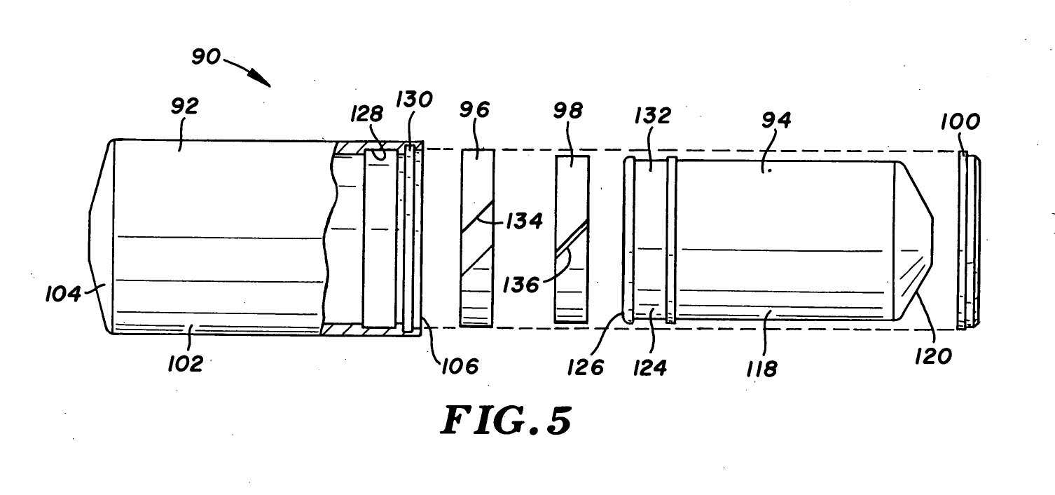

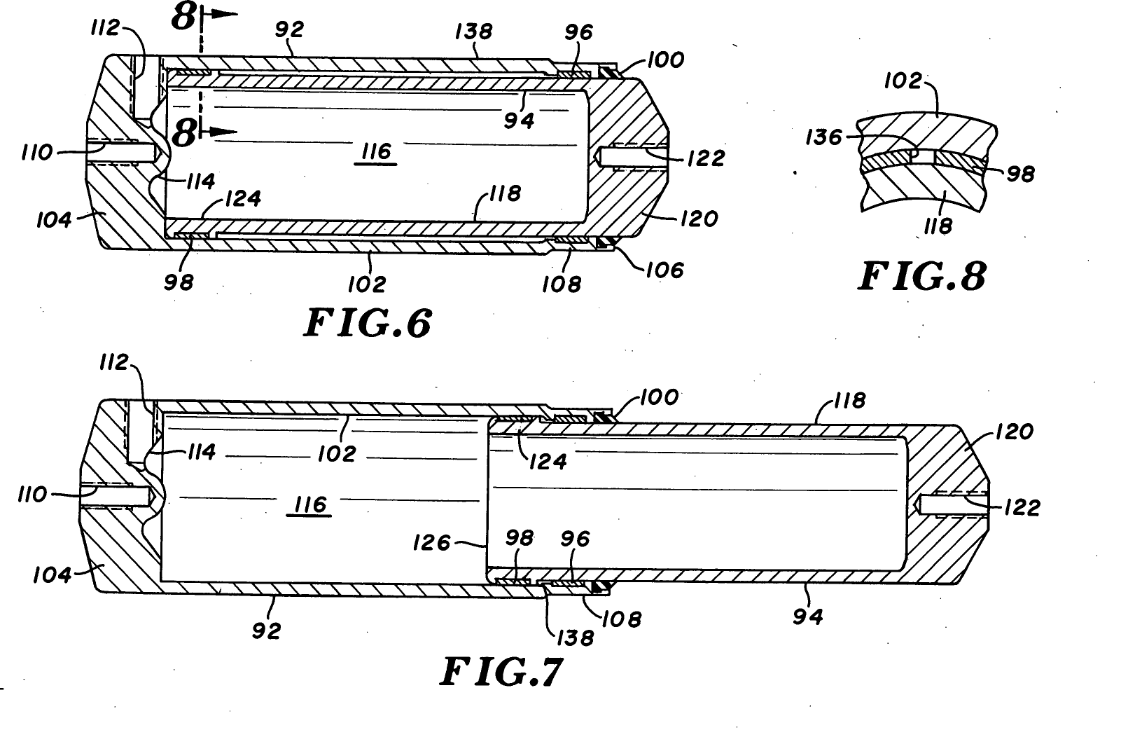

FIGS. 5-8 illustrate another alternative fluid actuator 90 with a telescoping housing and related components including an outer actuator housing section 92, an inner actuator housing section 94, bearings 96 and 98, and an annular seal 100. Outer housing section 92 includes a side wall 102, an end wall 104, an open end 106 opposite the end wall—and in the finished actuator (FIGS. 6 and 7), an annular end region 108 having a reduced diameter. End wall 104 accommodates a centered axially extending opening 110 to mount the actuator, and a radial (vertical in FIGS. 6 and 7) fluid passage 112. An annular depression 114 in the end wall is fluid-coupled to passage 112, and thus cooperates with the passage to admit fluid into a chamber 116 of the housing.

Inner housing section 94 includes a side wall 118, an end wall 120 accommodating an axial opening 122 used to mount the actuator, and an end region 124 near an open end 126 of the housing section. End region 124, in contrast to end regions 42 and 80 of the previous embodiments, is not formed by radially enlarging the side wall. Consequently, the inside diameter of the inner housing section is uniform, although the outside diameter is larger at the end region.

An advantage of the telescoping cylinder housing is the relative ease and low cost of its manufacture. With reference to FIG. 5, manufacturing begins with forming housing sections 92 and 94, by impact extrusion of an aluminum alloy. The housing sections are machined to provide certain features to facilitate assembly, e.g. an annular groove 128 near the open end of housing section 92 to accommodate bearing 96, and an annular groove 130 shaped to accommodate seal 100. Similarly, an annular groove 132 is formed along the outside surface of housing section 94 to accommodate bearing 98.

After machining, the bearings are installed into their respective grooves. Bearings 96 and 98 are formed with breaks or scarf cuts as indicated at 134 and 136, respectively. This facilitates radial expansion and contraction of each bearing into a close, conforming fit against its associated side wall. With respect to bearing 96, scarf cut 134 facilitates a radial reduction of the bearing when end region 108 is radially reduced during actuator assembly. In connection with bearing 98, scarf cut 136 provides a passage between the side walls that allows movement of oil or air across the wear surface between the chamber and an annular gap 138 between the side walls.

After its insertion into groove 128, bearing 96 retains a diameter larger than that of bearing 98. This permits insertion of inner housing section 94, with bearing 98 surrounding end region 124, axially into outer housing section 92 to locate end region 124 inwardly of end region 108 such that open end 126 confronts end wall 104. After insertion of inner housing section 94, seal 100 is inserted into groove 130. The seal is retained, although somewhat loosely, since at this stage the groove has a diameter larger than the seal diameter.

With housing section 94 thus inserted, outer housing section 92 is crimped along end region 108. This is a cold working stage in which the aluminum side wall is permanently (i.e. plastically) deformed to reduce the diameter along the end region. Crimping also radially compresses bearing 96, by narrowing scarf cut 134. Finally, crimping reduces groove 130 more closely about seal 100, to positively retain the seal.

The assembly of actuators 16 and 60 is substantially the same, with an additional plastic deformation step. Specifically, side wall 36/70 of inner housing section 20/62 is plastically deformed along end region 42/80 to increase the side wall diameter. The side wall is enlarged in this fashion before the inside housing section is machined or inserted into the outside housing section, either before or after placement of the bearing into the groove.

As shown in FIG. 8, scarf cut 136 forms a gap between side walls 102 and 1 18 in the finished actuator. This permits air, or oil in hydraulic versions, to pass freely between chamber 116 and gap 138. Thus, as inner housing section 94 moves axially from the retracted state (FIG. 6) toward the extended state (FIG. 7), the actuator fluid flows from the gap into the chamber, avoiding a pressure buildup that otherwise would resist housing extension. As best seen in FIG. 7, end regions 108 and 124 encounter each other when the housing is extended to a predetermined point, preventing further extension and reducing gap 138 to its minimum size. Subsequent retraction of the housing causes air or oil to flow from the chamber into the gap.

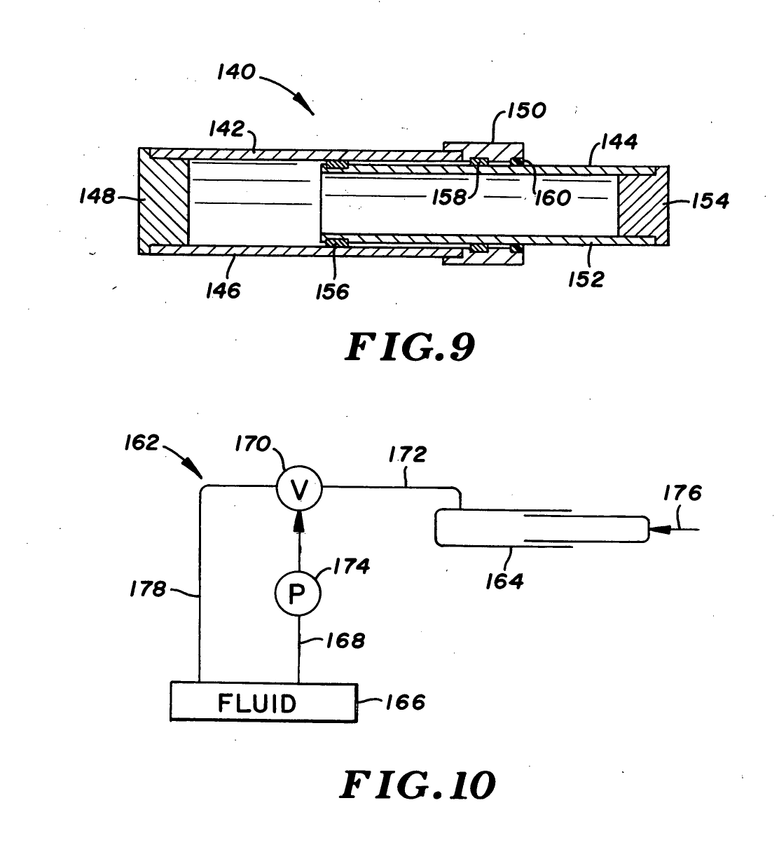

FIG. 9 shows an alternative embodiment fluid actuator 140 in which an outer actuator housing section 142 and an inner actuator housing section 144 are each composed of several parts. Outer housing section 142 includes a side wall 146, an end cap 148 threadedly coupled to the side wall, and an annular retaining feature 150 threadedly coupled to the other end of the side wall. Inside housing section 144 includes a side wall 152, and an end cap 154 threadedly coupled to the side wall. An annular bearing 156 surrounds the side wall near the end opposite from end cap 154.

An opening through retaining feature 150 accommodates longitudinal sliding of inner housing section 144. Annular grooves in feature 150 accommodate a bearing 158 maintained in sliding engagement with side wall 152, and an annular seal 160 maintained in sliding, wiping engagement with the side wall.

Actuator 140 avoids the need to crimp either of the side walls, but requires considerably more precision machining.

FIG. 10 schematically illustrates a system 162 configured according to the present invention. The system includes a fluid actuator 164 similar to actuator 90, although any of the previously discussed embodiments would suffice. An actuator fluid supply 166 is coupled to the fluid actuator through a supply line 168, a bidirectional valve 170 and a line 172. Line 172 is coupled to a fluid passage through the end wall similar to passage 112, to complete a fluid supply path to the chamber inside actuator 164. A fluid pump 174 along line 168 is operable to supply the fluid under pressure to the chamber, to extend actuator 164 against a force that tends to keep the actuator retracted, represented by the arrow at 176. In conjunction with the telescoping section design, when valve 170 is operated to direct fluid from line 172 to line 178, the fluid is evacuated from actuator 164 by action of force 176. The positive pressure created in actuator 164 by the action of force 176 further minimizes the chance for infiltration of environmental particulates and contaminants near the actuator even during the retraction of actuator 164.

Line 172, valve 170 and a return line 178 from the valve to fluid supply 166 form a fluid return path from the chamber to the fluid supply. Valve 170 is operable in concert with pump 174 to direct the actuator fluid from line 168 to line 172 when the pump is applying a positive pressure, and alternatively to direct fluid from line 172 to return line 178 when the pump is not active.

Thus in accordance with the present invention, fluid actuators and systems employing fluid actuators can be manufactured and configured more quickly, require fewer component parts, and are more resistant to infiltration of particles and other contaminants suspended in the surrounding air. Elimination of the piston and piston rod found in conventional actuators also reduces the number of seals required. As a result, fluid actuators and systems are produced at lower cost, yet afford long-term, reliable performance.

What is claimed is:

1. A fluid actuator, including:
a first actuator housing section having a first-section end wall, a first open end opposite the first-section end wall, and a first-section side wall extending in a longitudinal direction between the first-section end wall and the first open end;
a second actuator housing section having a second-section end wall, a second open end opposite the second-section end wall, and a second side wall extending in a longitudinal direction between the second-section end wall and the second open end;
wherein the second actuator housing section is disposed in opposition to the first actuator housing section with the second-section side wall surrounded by the first-section side wall and with the second open end confronting the first-section end wall, whereby the first and second actuator housing sections cooperate to form an actuator housing with an enclosed chamber extending longitudinally between the first-section end wall and the second-section end wall;
wherein the second actuator housing section is adapted to reciprocate longitudinally with respect to the first actuator housing section, between an extended state in which the first-section end wall and second-section end wall are relatively remote from each other, and a retracted state in which the first-section end wall and the second-section end wall are relatively proximate to each other, thus to alternatively longitudinally expand and contract the actuator housing; and
a fluid supply component fluid-coupled to the chamber and adapted to supply an actuator fluid under pressure to the chamber, to longitudinally expand the actuator housing.

2. The actuator of claim 1 wherein:
the first and second actuator housing sections are elongate in the longitudinal direction.

3. The actuator of claim 2 wherein:
the first-section and second-section side walls are cylindrical and centered on a longitudinal axis, and an inside diameter of the first-section side wall is greater than an outside diameter of the second-section side wall.

4. The actuator of claim 3 wherein:
the first-section side wall has a reduced diameter along an annular side wall segment proximate the first open end.

5. The actuator of claim 4 wherein:
the second-section side wall has an enlarged diameter along an annular side wall segment proximate the second open end.

6. The actuator of claim 3 further including:
an annular band contiguous with an inside surface of the first-section side wall proximate the first open end.

7. The actuator of claim 6 further including:
an annular band surrounding the second actuator housing section and contiguous with an outside surface of the second-section side wall proximate the second open end.

8. The actuator of claim 1 further including:
first and second limiting features integral with the first and second actuator housing sections near the first and second open ends respectively, disposed to engage each other when the actuator housing is longitudinally expanded to the extended state to prevent further longitudinal expansion.

9. The actuator of claim 1 wherein:
the first-section end wall and the second open end are positioned to engage when the actuator housing is in the retracted state to prevent further longitudinal contraction of the actuator housing.

10. The actuator of claim 1 further including:
a flexible seal disposed between the first-section side wall and the second-section side wall proximate the first open end.

11. The actuator of claim 1 wherein:
the fluid supply component includes a fluid source, a supply line fluid-coupling the fluid source with the actuator housing, and a pump along the supply line for conveying fluid from the fluid source to the actuator housing.

12. The actuator of claim 11 wherein:
the first-section end wall includes a fluid passage formed therethrough for fluid coupling the supply line and the chamber.

13. The actuator of claim 11 wherein:
the fluid is compressible.

14. A process for assembling a fluid actuator housing, including:
providing a first actuator housing section having a first-section end wall, a first open end opposite the first-section end wall, and a first-section side wall extending in an axial direction between the first-section end wall and the first open end;
providing a second actuator housing section having a second-section end wall, a second open end opposite the second-section end wall, and a second-section side wall extending in an axial direction between the second-section end wall and second open end, wherein an outside diameter of the second-section side wall is less than an inside diameter of the first-section side wall;
inserting the second actuator housing section axially into the first actuator housing section such that the first-section side wall surrounds the second-section side wall and the second open end confronts the first-section end wall;
with the second actuator housing section so inserted, permanently radially reducing an end region of the first-section side wall proximate the first open end, to secure the second actuator housing section against removal from the first actuator housing section while permitting the second actuator housing section to travel axially relative to the first actuator housing section.

15. The process of claim 14 further including:
after so inserting the second actuator housing section and before radially compressing said end region, mounting a seal between the first-section and second-section side walls.

16. The process of claim 15 wherein:
mounting the seal comprises installing the seal integrally with respect to the first-section side wall proximate the first open end, and slideably with respect to the second-section side wall.

17. The process of claim 14 further including:
before so inserting the second actuator housing section, mounting an annular band contiguous with an inside surface of the first-section side wall proximate the first open end.

18. The process of claim 14 further including:
before so inserting the second actuator housing section, mounting an annular band in surrounding relation to the second-section side wall and contiguous with an outside surface of the second-section side wall proximate the second open end.

19. The process of claim 14 further including:
with the second actuator housing section so inserted, radially expanding an end region of the second-section side wall proximate the second open end, to further secure the second actuator housing section against removal while permitting said axial travel.

20. The process of claim 14 further including:
providing a first limiting feature extending radially inwardly from the first-section side wall near the first open end, and a second limiting feature extending radially outwardly from the second-section side wall near the second open end, and selectively positioning the first and second limiting features for an engagement with each other to prevent said axial travel beyond a predetermined extension.

21. A fluid actuator system including:
an actuator housing comprising a first actuator housing section having a first end wall and an axially extending first side wall, and a second actuator housing section having a second end wall and an axially extending second side wall;
wherein the second actuator housing section is mounted to reciprocate axially relative to the first actuator housing section between extended and retracted states with the first side wall in surrounding relation to the second side wall, whereby the first and second actuator housing sections cooperate to define a chamber with the first and second end walls disposed at opposite ends of the actuator housing to determine opposite ends of the chamber;
a fluid source containing a fluid;
a fluid supply path extending from the fluid source to the chamber; and
a fluid pump disposed along the fluid supply path operable to convey the fluid from the fluid source into the chamber under pressure to cause the second actuator housing section to travel toward the extended state.

22. The system of claim 21 wherein:
the fluid supply path comprises a fluid passage formed through the first end wall.

23. The system of claim 21 wherein:
the fluid is substantially incompressible.

24. The system of claim 21 wherein:
the first and second side walls are cylindrical and elongate in the axial direction.

25. The system of claim 24 wherein:
the first side wall includes a radially reduced end region near an open end of the first actuator housing section opposite the first end wall.

26. The system of claim 25 wherein:
the second side wall includes a radially enlarged end region proximate an open end of the second actuator housing section opposite the second end wall.

27. The system of claim 24 further including:
an annular band contiguous with an inside surface of the first side wall near an open end of the first actuator housing section opposite the first end wall.

28. The system of claim 27 further including:
an annular band surrounding the second side wall and contiguous with an outer surface of the second side wall near an open end of the second actuator housing section opposite the second end wall.

29. The system of claim 21 further including:
a first limiting feature extending radially inward from the first side wall, and a second limiting feature extending radially outward from the second side wall, wherein the first and second limiting features are selectively positioned to engage upon a predetermined extension of the actuator housing to prevent further axial extension.

30. The system of claim 21 further including:
a seal disposed between the first side wall and second side wall, mounted integrally with respect to the first side wall and slideably with respect to the second side wall.
